(19) United States
(12) Patent Application Publication
(10) Pub. No.: US 2011/0253070 A1
(43) Pub. Date: Oct. 20, 2011

(54) Hydrogen generator

(76) Inventor: Christopher Haring, New Orleans, LA (US)

(21) Appl. No.: 12/798,962

(22) Filed: Apr. 14, 2010

(51) Int. Cl. F02B 43/08

(52) U.S. Cl. 123/3

(57) ABSTRACT

A hydrogen generator for apparatus for use in an internal combustion engine of a vehicle for increasing the efficiency of the engine and decreasing emissions from the engine has stainless-steel electrolysis plates that are close-spaced in the generator housing. The hydrogen unit is configured to inject hydrogen after the throttle body and the carburetor using a spacer located between the intake manifold and the throttle body or carburetor. Alternative, a modified spark plug equipped with a tube and a check valve is mounted on the engine, while being controlled by the generator's PCB controller. The PCB controller is configured to control a variety of operational control devices, including a gas level controller, a liquid level controller, a temperature controller, a pressure controller, a flow rate controller, a current controller a tachometer controller, a pressure sensor configured to detect gas pressure in the housing, a liquid sensor configured to detect level of aqueous solution in the housing, and a temperature sensor. The operational conditions of the hydrogen generator can be controlled from a cab of the vehicle.

### BACKGROUND OF THE INVENTION

The present invention relates to hydrogen generating apparatus and, more particularly, to hydrogen generating apparatus for use in motor vehicles to increase the performance of the engine of the motor vehicle.

Federal regulations require that automobile manufacturers improve fuel efficiency and emissions control. The addition of hydrogen gas and oxygen gas to the fuel system of an internal combustion engine is known to improve fuel efficiency and decrease the emission of undesired pollutants. These benefits are thought to be the result of more complete combustion induced by the presence of hydrogen in fuel, as a consequence of which efficiency increases, while dangerous emissions with soot and carbon monoxide—decrease.

The hydrogen and oxygen may be generated through electrolysis of an aqueous solution with the gases given off being mixed with the fuel and air supplied to the engine. The hydrolysis of water is known to produce both hydrogen gas and oxygen gas. The generation of small quantities of hydrogen and oxygen using one or more electrolysis cells with the hydrogen and oxygen generated then being combined with the usual air/fuel mixture to improve the efficiency of internal combustion engines has been proposed in a number of published documents.

The car industry produced hydrogen devices called electronic fuel injection enhancers (EFIE) that can be used for retrofitting a car. Basically, they use the process of electrolysis to introduce a small amount of hydrogen gas to the air that's already being drawn into the engine. As a result, the mix of air/hydrogen gas causes greater ignition and burns much better. This gives higher fuel efficiency and in some cases can actually cause the exhaust coming out of the engine to be more oxygen rich and cleaner, taking away the need for a catalytic converter. The electricity needed for the electrolysis is drawn off of the car's alternator to create what is called HHO, or oxyhydrogen, or brown gas.

Since hydrogen is flammable, care should be exercised when retrofitting a vehicle with a hydrogen generator. The present invention contemplates provision of a hydrogen generator for use with a vehicle powered by a combustion engine that can be safely installed on a vehicle to improve fuel efficiency and decrease harmful emissions.

### SUMMARY OF THE INVENTION

It is, therefore, an object of the invention to provide a hydrogen generator that can be incorporated into a vehicle motor system in a safe and efficient manner.

It is another object of the invention to provide a hydrogen generator that employs water electrolysis for generation of hydrogen gas.

It is a further object of the invention to provide a hydrogen generator that incorporates closely-spaced electrode cells for increased rate of separation of oxygen and hydrogen in water molecules.

These and other objects of the invention are achieved through a provision of a A hydrogen generator for apparatus for use in an internal combustion engine of a vehicle for increasing the efficiency of the engine and decreasing emissions from the engine has stainless-steel electrolysis plates that are close-spaced in the generator housing. The hydrogen unit is configured to inject hydrogen after the throttle body and the carburetor using a spacer located between the intake manifold and the throttle body or carburetor. Alternative, a modified spark plug equipped with a tube and a check valve is mounted on the engine, while being controlled by the generator's PCB controller.

The PCB controller is configured to control a variety of operational control devices, including a gas level controller, a liquid level controller, a temperature controller, a pressure controller, a flow rate controller, a current controller a tachometer controller, a pressure sensor configured to detect gas pressure in the housing, a liquid sensor configured to detect level of aqueous solution in the housing, and a temperature sensor. The operational conditions of the hydrogen generator can be controlled from a cab of the vehicle.

BRIEF DESCRIPTION OF TILE DRAWINGS

Reference will now be made to the drawings, wherein like parts are designated by like numerals, and wherein

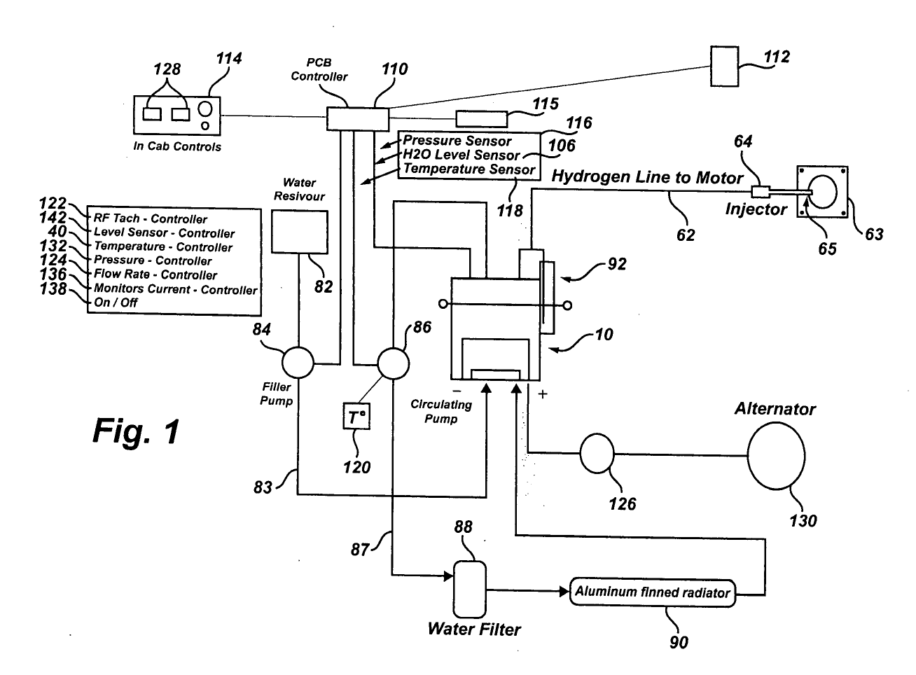

FIG. 1 is a schematic view of the hydrogen generator of the instant invention incorporated with vehicle controls.

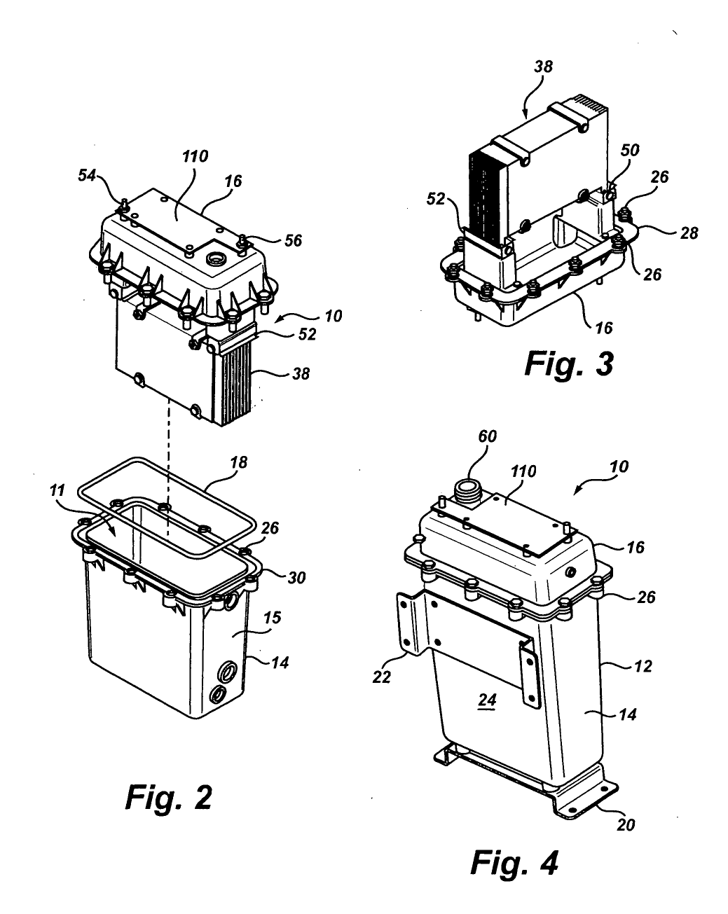

FIG. 2 is an exploded view of the hydrogen generator apparatus of the present invention.

FIG. 3 is a detail view of the hydrogen generator apparatus of the present invention, with the top cover removed.

FIG. 4 is a perspective rear view of the hydrogen generator apparatus of the present invention.

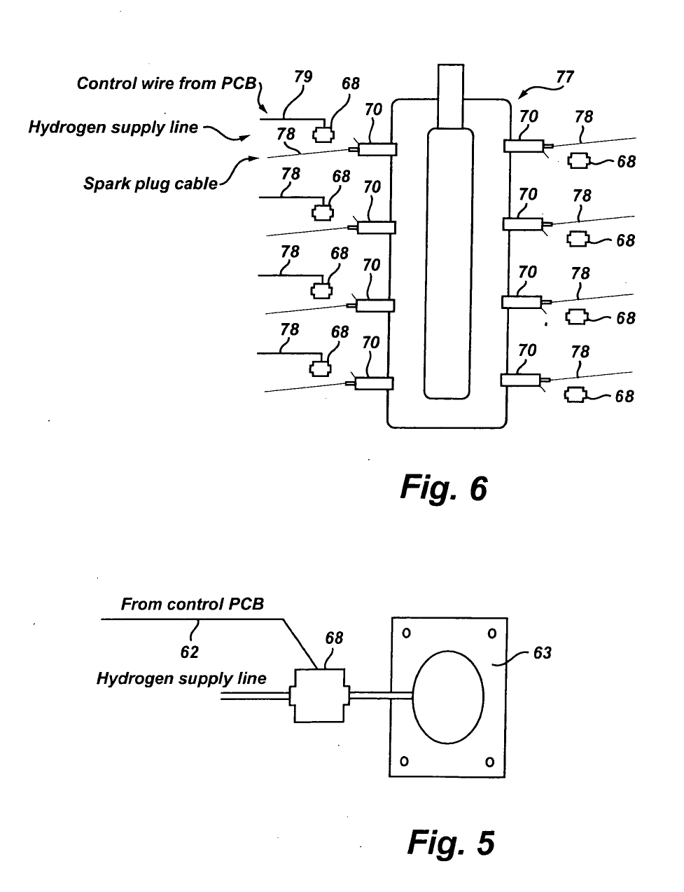

FIG. 5 is a schematic view illustrating a manner of incorporating the hydrogen generator of the present invention in a vehicle fuel intake system.

FIG. 6 is a schematic view illustrating a manner of incorporating the hydrogen generator of the present invention to a spark plug.

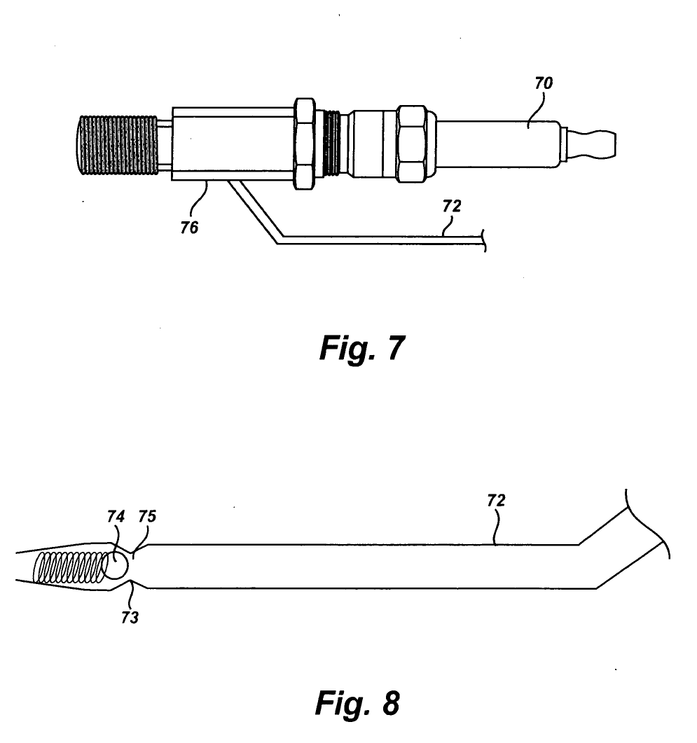

FIG. 7 is a plan view of a spark plug with a one-way valve for use with the apparatus of the present invention when delivering hydrogen to the engine.

FIG. 8 is a detail view illustrating a tube and check valve incorporated into the spark plug of FIG. 7.

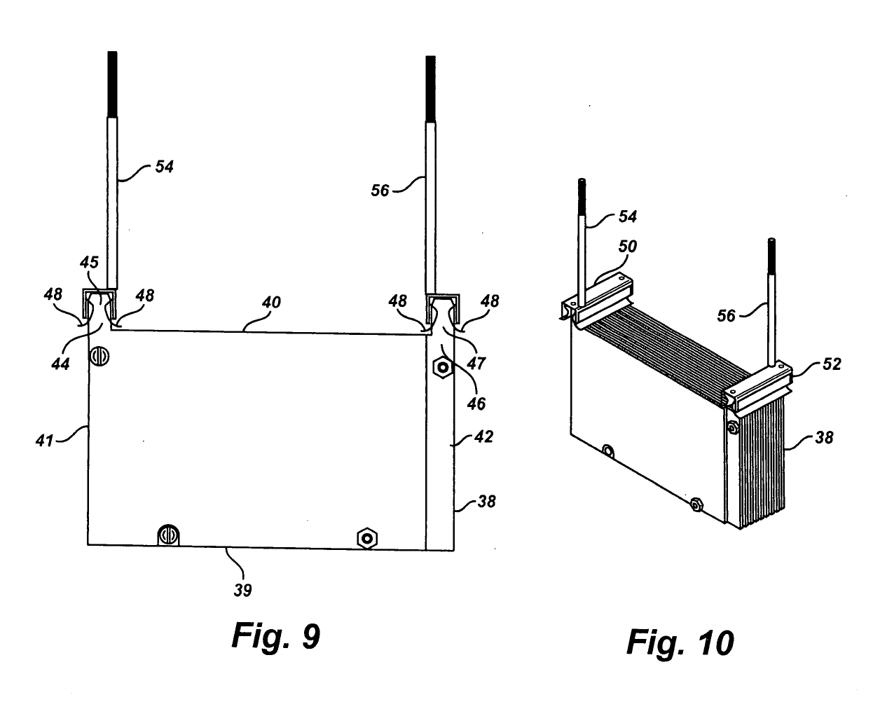

FIG. 9 is a detail font view of an electrode plate.

FIG. 10 is a perspective view of the electrode plates joined in series.

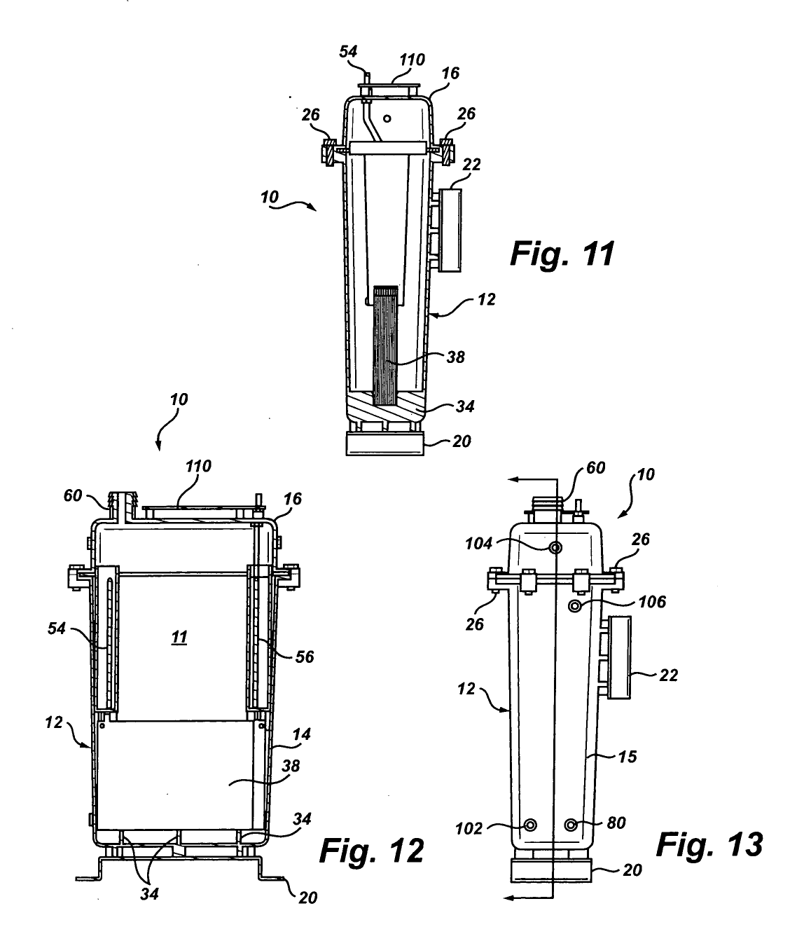

FIG. 11 is a vertical sectional view of the hydrogen generator of the present invention.

FIG. 12 is a side view of the hydrogen generator of the present invention.

FIG. 13 is a sectional view taken along lines A-A of FIG. 12.

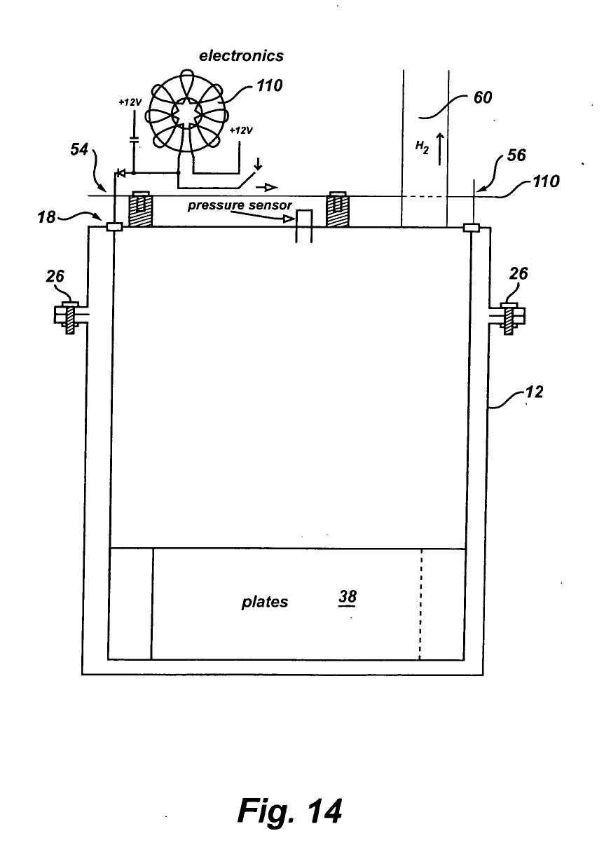

FIG. 14 is an electrical schematic of the connection between the electrode plates and the electrodes.

### DETAIL DESCRIPTION OF THE PREFERRED EMBODIMENT

Turning now to the drawings in more detail, numeral 10 designates the hydrogen generator apparatus according to the instant invention. The hydrogen generator 10 comprises an enclosure or housing 12 having an inner chamber 11, a hollow base 14 and a detachable cover 16. A sealing gasket 18 is secured between the cover 16 and the base 14 to prevent escape of the liquid from the housing 12. A bottom mounting bracket 20 is secured to the bottom plate of the base 14, and a rear mounting bracket 22 is secured to a back wall 24 of the housing 12. The mounting brackets 20, 22 are configured to mount the apparatus 10 on a vehicle in a position adjacent the vehicle engine.

A plurality of bolts 26 spaced about the peripheral flanges 28, 30 of the base 14 and the cover 16, respectively, detachably secure the cover 16 to the base 14. A plurality of support members or ridges 34 is secured the inside bottom of the base 14 support a series of electrode plates 38. The plates 38 are retained in a close albeit spaced-apart relationship to each other. The electrode plates 38 are preferably formed from a non-reactive material, such as stainless steel. The plates 38 are retained in their spaced relationship by the support members 34, 36.

In one aspect of the invention, the plates 38 are made from stainless steel 306-grade and about 1/16″ thick. The plates 38 can be parallel-spaced within 10-50 mm from each other, with one of the preferred spacing being in the order of 20 mm. In one aspect of the invention, the apparatus 10 comprises twenty electrode plates 38 having 0.5″ size sufficient to transfer energy without heat loss. Some experimental units demonstrated that twenty plates spaced at 20 mm apart allow 100 Amp of direct current to produce 1 Liter of hydrogen every 50 seconds utilizing tap water and no catalysts. It is envisioned that the apparatus of the present invention can employ catalysts, such as for instance sodium silver nitrate, in which case the amount of hydrogen produced by the generator 10 may be increased.

As can be seen in FIGS. 9 and 10, each plate 38 comprises a solid planar body, which can be rectangular, square, oval, round, etc. In the embodiment illustrated in these drawings, the plate 38 has a bottom edge 39, a top edge 40, and a pair of opposing sides 41, 42. Extending from the top edge 40 is a pair of projections 44, 46, each of which has a reduced width part 45, 47, respectively. Electrical contact members 48 are fitted into the grooves defined by the reduced parts 45, 47, such that each plate 38 has two contact points. The contact members 48 can be formed from stainless steel finger stock.

An elongated cap 50 fits over the tops of the projections 44, and a similar elongated cap 52 fits over the tops of the projections 46 of the series of plates 38. The caps 50, 52 are mounted in contact with the contact members 48. A electrode rod 54 is secured to the cap 50, and a second electrode 56 is secured to the cap 52. The electrodes 54, 56 are secured to diagonally opposing corners of the caps 50, 52, as can be seen in FIG. 10. The electrodes 54, 56 protrude from the top of the unit 10. The plates 38 are mounted close to the bottom of the base 14, such that air/hydrogen gap is created between the cover 16 and the water level in the housing 12. An alternative embodiment is to have the electrodes extend from the bottom of the housing 12 have electrodes and plates 38 totally submerged in water. In this case, it is envisioned that the electrodes will be shorter in length.

A gas outlet 60 is secured to the cover 16; the gas outlet 16 is in fluid communication with the chamber 11 formed by the housing 12. A conduit 62 (schematically shown in FIG. 1) connects the outlet port 60 to the engine block of a vehicle. In some embodiments, the base mounting plate 20 can be mounted under the carburetor or throttle body of the vehicle's engine block, using a throttle spacer 63 located between the intake manifold and the throttle body or carburetor. Hydrogen is delivered by an injector 64 having a nozzle 65. A gas flow control valve 68 is positioned in line between the hydrogen delivery line 62 and the injector 68 to control delivery of hydrogen to the motor to facilitate combustion of fuel.

In other embodiments, a spark plug 70 is modified with the addition of a hollow cylindrical gas tube 72, which connects the outlet port 60 with one or more spark plugs 70. The gas tube 72 is provided with a one-way check valve 74 fitted in the body of the gas tube 72. The injector plug is a key feature in creating the efficient burn. Hydrogen is injected into the spark plug port, through a channel and one way valve and exits next to the spark gap. This is done at the same time the spark is engaging, thus causing a rapid and hot detonation causing the fuel to rapidly and completely burn.

As can be seen in FIGS. 7 and 8, the gas tube 72 comprises a narrowed portion 73, which forms a reduced diameter opening 75. The check valve 74 can be in the form of a spherical body sized and configured to close the opening 75 to prevent backflow of gases. The gas tube 72 is secured to the spark plug 70 by a sleeve 76. The extender sleeve 76 is inserted into the vehicle's head where the spark plug normally fits, then the spark plug is inserted into the extender sleeve.

FIG. 16 schematically illustrates introduction of hydrogen generated by the unit 10 into an eight-cylinder engine 77. In this embodiment, each spark plug 70 is equipped with a spark plug cable 78 connecting the spark plug to the vehicle electronic controls. A control wire 79 from a PCB controller 110 regulates operation of flow control valves 68 for each spark plug 70. In this embodiment, hydrogen is sprayed on the tip of the spark plug through the hydrogen injector nozzle during the spark phase. By doing this the ignition spark is raised from 0.001 Joules to a magnitude of 10 Joules, which is far superior to any spark enhancing method known today.

As an added advantage of focusing delivery of hydrogen to the ignition point, the apparatus 10 uses less hydrogen. The hydrogen detonates in 3 milliseconds which accelerates the burning of the gasoline, diesel and so on. The slower type burning fuel such as diesel will produce a higher efficiency number compared to gasoline. Natural gas will produce better numbers than diesel or gasoline. This acceleration of burning the fuel generates more horse power, increases torque and fuel mileage of the vehicle, while reducing harmful emissions. The preliminary tests showed that the slower burning type of fuel is used by the vehicle, the better the affect the hydrogen has on that fuel. For instance, diesel-powered vehicles achieve a better efficiency level than gasoline-powered engine because diesel naturally burns slower than gasoline. Therefore, when hydrogen that detonates at 3 milliseconds is added to these fuels it raises their burn rate thus getting more efficiency out of the fuels.

A side wall 15 of the base 14 is provided with a water port 80, which connects the housing 12 to a water reservoir 82. A filler pump 84 is positioned in waterline 83 delivering water to the chamber 11. The water is circulated through the chamber 11 using a circulating pump 86, which is connected to the housing 12 via a circulating line 87 equipped with a water filter 88. In one aspect of the invention, the circulating line 87 is fluidly connected to the vehicle radiator 90. The filter 88 is in line with the radiator 90, which is controlled by the temperature controller 120, which in turn activates the circulation pump 86 to cool the generator down.

A means for creating turbulence 92 inside the chamber 11 is positioned in fluid communication with the housing 12. The turbulence creator 92 allows the water to circulate from bottom to top of the housing. For this reason it is preferred that at least 1″ space is left all the way around, the top and bottom of the plates 38. The bubbles created by the turbulence creator 92 allow hydrogen molecules to be released from the plates 38 and rise to the top of the chamber 11 in a speedy manner. It should be noted that the plates 38, although closely spaced from each other, are positioned at sufficient distance not to impede water circulation.

An optional electrode port 102 is formed in the wall 15 for positions when the electrodes protrude from the housing 12 near the bottom of the housing. A pressure relief valve 104 is mounted near the upper portion of the housing 12 to allow selective release of gas pressure built up in the housing 12. A water level sensor 106 is incorporated into the unit 10 to regulate the level of liquid inside the chamber 11.

A main PCB controller 110 is mounted on top of the cover 16. The printed circuit board 110 is operationally connected to the vehicle electronic control unit (ECU). A special port 112 connects the PCB controller 110 to the onboard diagnostic system (OBD) of the vehicle. The PCB controller 110 is also connected to in-cab control panel 114.

The main controller 110 allows for the best operational efficacy and performance from the engine by adjusting and or monitoring air fuel ratios, timing, mass air flow sensor, oxygen sensor, flow and production of hydrogen and safety features. An ECU module controller 115, connected to the PCB controller 110, reads and writes information to/from the vehicle ECU. This control allows for the best operational efficacy and performance from the engine by monitoring and adjusting engine perimeters. air fuel ratios, timing, mass air flow censor, oxygen sensor, and cam/crank position.

The controller 110 controls operation of a pressure sensor 116, ensuring that the pre-selected pressure is built and maintained in the hydrogen generator 10. The pressure sensor device detects the pressure in the hydrogen generator housing 12 and regulates that pressure by either shutting off the power from the alternator 130 or by injecting more hydrogen into the motor.

The water level sensor 106, also connected to the controller 110 senses when the water levels drops below a pre-determined level and activates the filter pump 88, which pulls water from the water reservoir 82 to fill the housing 12. It is estimated that the unit 10 will use 8-9 cups of water for a 10-hour operation.

The main controller 110 also co-operates with a temperature sensor 118 and sends a signal to a temperature controller 120 to send a signal to the circulating/cooling pump 86 to circulate water through the radiator 90 and back to the unit 10. The temperature controller 120 is configured to send a signal to the controller 110 for controlling operational temperature parameters of 35-170 F. Out-of-range conditions detected by the temperature sensor 118 cause shut unit down of the unit 10. The temperature controller 120 also controls the circulating pump 86 for cooling of the hydrogen unit. The filtration system 88, which is in line with the radiator 90 is activated by the temperature controller 120.

The PCB controller 110 also controls RF tachometer 122 such that the flow of hydrogen into the engine of the vehicle is regulated depending on the rotational speed of the engine. The RF tachometer 122 is preferably a wireless unit. The radio frequency tachometer 122 accurately reads the RPM of the engine. It is responsible for flow control of the hydrogen, metering of the hydrogen, whether engine is running or not.

A flow rate controller 124 operationally connected to the controller 110 is configured to control the amount of hydrogen delivered into the engine system through the injector 64 and valves 68. The flow rate controller 124 is provided with an on-/off switch to automatically adjust delivery of hydrogen upon demand by the engine system. By default, it is closed or off.

A master on-off switch 126 and in-cab control 128 are also controlled by the PCB controller 110. The switches 126 and controls 128 show to the driver at what pressure the unit is operating, whether it is “on,” water level, and how much current is being drawn by the engine. In one aspect of the invention, the operating pressure can be controlled from a cab, in other aspects—the preferred data can be factory preset, so that the unit 10 can operate automatically. The on/off relay switch 126 is operationally connected to the vehicle alternator 130.

A pressure controller 132 controls the internal pressure of the hydrogen generator which operates in the 100-200 p.s.i. range depending on the settings. Should the pressure in the unit fall below the designated range, the flow control is shut off until pressure is at least 100 p.s.i. Should the pressure sensor detect pressure above 200 p.s.i. the pressure sensor sends a signal to the pressure controller 132, and the unit stops making hydrogen until pressure falls back into the designated range.

A level controller 134 controls the filler pump 86, which keeps the level of water in the containment unit above the electrolysis plates, and the circulation pump for filtering and cooling the water. A current controller 136 monitors current in the hydrogen generator 10; the current controller is operationally connected to and is controlled by, the PCB controller 110. The PCB controller also sends an on/off signal to the unit 10 through a switch 138.

The apparatus of the instant invention is provided with safety controls. The control board 110 only turns on the hydrogen unit under these conditions otherwise the unit is disengaged. When the vehicle is in drive, unit pressure comes into range 100-200 psi, amps are in range +100 amps, rpm are at 500 minimal, water level is proper—only then the PCB controller 110 directs the start of the unit 10.

A temperature controller 140 on the body of the generator senses the need for circulating the water (source of the hydrogen) through the generator though a cooling regulator which is incorporated with a filter 88 for removing the sediments from the water. In some of the preferred embodiments, the water is distilled water.

A level controller 142, connected to the level sensor, is operated by the PCB controller 110 to ensure that the water in the generator 10 is maintained at a pre-determined level so that the water is always above the plates 38.

The electrode plates 38 as illustrated in the drawings are shown as a series of rectangular or square electrode plates although other configurations of the electrode assembly are possible. For instance, the electrode assembly could comprise a series of bar electrodes arranged in a suitable array, or the electrode assembly could be a plurality of concentric circular electrodes. The electrode plate assembly provides for a multi-cell bipolar electrode assembly for increased efficiency of the electrolysis reaction in the hydrogen generator apparatus 10.

The materials from which the electrode plates are made are selected to minimize the effects of different coefficients of expansion of the materials, withstand strong corrosive action of the electrolyte solution and provide effective and efficient electrolysis process. Thus, preferably, the electrode plates 38 are made from a suitable stainless steel material. The housing 12 can be formed from stainless steel, aluminum, or other suitable material to withstand the corrosive environment.

Many changes and modifications can be made in the design of the present invention without departing from the spirit thereof. I, therefore, pray that my rights to the present invention be limited only by the scope of the appended claims.

I claim:

1. A hydrogen generating apparatus for use in an internal combustion engine of a vehicle for increasing the efficiency of the engine and decreasing emissions from the engine, the hydrogen generating system comprising:
a hollow housing having a detachable top cover;
a means for securing the housing on said vehicle;
a plurality of electrolysis members mounted in said housing and configured to generate hydrogen gas by electrolysis of an aqueous solution, the electrolysis members being electrically connected in series;
a means for introducing the generated gas into the internal combustion engine;
a means for controlling operating conditions of the hydrogen generating apparatus operationally connected to a vehicle electronic control unit accessible in a user-occupied part of the vehicle, said controlling means comprising a main controller mounted on said housing, and a plurality of control units supplying information to, and operated by, the main controller, said plurality of control units comprising a gas level controller, a liquid level controller, a temperature controller, a pressure controller, a flow rate controller, a current controller and a tachometer controller.

2. The apparatus of claim 1, wherein said means for controlling the operating conditions further comprises a pressure sensor configured to detect gas pressure in the housing, a liquid sensor configured to detect level of aqueous solution in the housing, and a temperature sensor configured to detect temperature inside the housing.

3. The apparatus of claim 1, further comprising a means for delivering aqueous solution to the housing.

4. The apparatus of claim 3, wherein said means for delivering aqueous solution comprises a pump operationally connected to a source of aqueous solution.

5. The apparatus of claim 2, further comprising a means for regulating temperature of the aqueous solution in the housing.

6. The apparatus of claim 5, wherein a means for regulating temperature of the aqueous solution comprises a circulating pump operationally connected to the housing and to the temperature controller such that detection of out-of-range temperature conditions causes initializing of the circulating pump.

7. The apparatus of claim 1, wherein said means for introducing the generated gas into the internal combustion engine comprises a hydrogen supply conduit mounted between the housing and a throttle of the vehicle engine, an injector nozzle for introducing generated hydrogen gas into the engine, and a flow control valve controlled by the main controller and mounted upstream of the injector nozzle.

8. The apparatus of claim 7, wherein said means for securing the housing comprises a mounting bracket and spacer plate configured for securing on the throttle of the vehicle engine.

9. The apparatus of claim 1, wherein said means for introducing the generated gas into the internal combustion engine comprises a spark plug, having an elongated tube secured thereon, a hydrogen supply line connected to the elongated tube and a check valve mounted in said elongated tube.

10. The apparatus of claim 1, further comprising a flow control valve operationally connected to the main controller.

11. The apparatus of claim 1, further comprising a means for creating turbulence in the housing configured to facilitate circulation of aqueous solution around the electrolysis members.

12. The apparatus of claim 11, wherein said electrolysis members are mounted adjacent a bottom of the housing, and wherein a circulation space is formed around the electrolysis members.

13. The apparatus of claim 1, wherein each of said electrolysis members comprises a solid planar body having a top edge, and wherein a pair of projections extends from opposite corners of the top edge of the planar body.

14. The apparatus of claim 13, wherein each of the projections comprises a reduced width part defining a groove, and wherein an electrical contact member is fitted into the groove.

15. The apparatus of claim 13, wherein said electrolysis members are secured in a parallel spaced-apart relationship to each other, and wherein an elongated cap is fitted over tops of aligned projections of the electrolysis members.

16. The apparatus of claim 1, wherein 15, wherein a distance between the electrolysis members is within a range of between 10 and 50 mm.

17. The apparatus of claim 1, wherein each of said electrolysis members of formed from stainless steel.

18. A hydrogen generating apparatus for use in an internal combustion engine of a vehicle for increasing the efficiency of the engine and decreasing emissions from the engine, the hydrogen generating system comprising:
a hollow housing having a detachable top cover;
a means for securing the housing on said vehicle;
a plurality of stainless steel electrolysis members mounted in said housing and configured to generate hydrogen gas by electrolysis of an aqueous solution, the electrolysis members being electrically connected in series;
a means for introducing the generated gas into the internal combustion engine;
a means for controlling operating conditions of the hydrogen generating apparatus operationally connected to a vehicle electronic control unit accessible in a user-occupied part of the vehicle, said controlling means comprising a main controller mounted on said housing, and a plurality of control units supplying information to, and operated by, the main controller, said plurality of control units comprising a gas level controller, a liquid level controller, a temperature controller, a pressure controller, a flow rate controller, a current controller a tachometer controller, a pressure sensor configured to detect gas pressure in the housing, a liquid sensor configured to detect level of aqueous solution in the housing, and a temperature sensor configured to detect temperature inside the housing.

19. The apparatus of claim 18, wherein each of said electrolysis members comprises a solid planar body having a top edge, and wherein a pair of projections extends from opposite corners of the top edge of the planar body.

20. The apparatus of claim 19, wherein each of the projections comprises a reduced width part defining a groove, and wherein an electrical contact member is fitted into the groove.

21. The apparatus of claim 18, wherein said electrolysis members are secured in a parallel spaced-apart relationship to each other, and wherein an elongated cap is fitted over tops of aligned projections of the electrolysis members.

22. The apparatus of claim 18, wherein said electrolysis members are closely-spaced, and wherein a distance between adjacent electrolysis members is within a range of between 10 and 50 mm.

23. The apparatus of claim 18, wherein said means for delivering aqueous solution comprises a pump operationally connected to a source of aqueous solution.

24. The apparatus of claim 18, further comprising a means for regulating temperature of the aqueous solution in the housing, said means for regulating temperature of the aqueous solution comprising a circulating pump operationally connected to the housing and to the temperature controller such that detection of out-of-range temperature conditions causes initializing of the circulating pump.

25. The apparatus of claim 18, wherein said means for introducing the generated gas into the internal combustion engine comprises a hydrogen supply conduit mounted between the housing and a throttle of the vehicle engine, an injector nozzle for introducing generated hydrogen gas into the engine, and a flow control valve controlled by the main controller and mounted upstream of the injector nozzle.

26. The apparatus of claim 25, wherein said means for securing the housing comprises a mounting bracket and spacer plate configured for securing on the throttle of the vehicle engine.

27. The apparatus of claim 18, wherein said means for introducing the generated gas into the internal combustion engine comprises a spark plug, having an elongated tube secured thereon, a hydrogen supply line connected to the elongated tube and a check valve mounted in said elongated tube.

28. The apparatus of claim 18, further comprising a flow control valve operationally connected to the main controller.

29. The apparatus of claim 18, further comprising a means for creating turbulence in the housing configured to facilitate circulation of aqueous solution around the electrolysis members.

30. The apparatus of claim 29, wherein said electrolysis members are mounted adjacent a bottom of the housing, and wherein a circulation space is formed around the electrolysis members.
